(19) United States
(12) Patent Application Publication
(10) Pub. No.: US 2026/0172502 A1
(43) Pub. Date: Jun. 18, 2026

(54) ELECTRONIC DEVICE, METHOD, AND NON-TRANSITORY STORAGE MEDIA FOR CHANGING SCREEN DISPLAYED ON DISPLAY

(71) Applicant: SAMSUNG ELECTRONICS CO., LTD., Suwon-si (KR)

(72) Inventors: Joonghwan LEE, Suwon-si (KR); Jaewoo SEO, Suwon-si (KR); Bumjun KWON, Suwon-si (KR); Jungil CHO, Suwon-si (KR); Moongyu JUNG, Suwon-si (KR); Youngbae JEON, Suwon-si (KR); Iljoo KIM, Suwon-si (KR)

(21) Appl. No.: 19/425,099

(22) Filed: Dec. 18, 2025

Related U.S. Application Data
(63) Continuation of application No. PCT/KR2025/022163, filed on Dec. 18, 2025.

(30) Foreign Application Priority Data
Dec. 18, 2024 (KR) 10-2024-0189925
Nov. 5, 2025 (KR) 10-2025-0165658

(51) Int. Cl. H04M 1/72463; H04M 1/72403; H04N 9/31

(52) U.S. Cl. CPC H04M 1/724631; H04M 1/72403; H04N 9/3182

(57) ABSTRACT

An electronic device may include a display, at least one processor including circuitry, and memory storing instructions which, when individually and/or collectively executed by the at least one processor, cause the electronic device to: display a screen including a first image representing first information on the display; identify information related to a pixel of at least one of an inner part or an outer part with respect to a boundary between an object representing the first information included in the first image and a background excluding the object; obtain a second image in which at least one of the inner part or the outer part is adjusted; obtain a third image in which the background included in the first image is blurred; obtain a fourth image using the second image and the third image, the fourth image being processed such that the first information is not discernible to a naked eye beyond a specified distance; and replace the first image displayed on the screen with the fourth image.

### CROSS-REFERENCE TO RELATED APPLICATIONS

This application is a continuation of International Application No. PCT/KR2025/022163 designating the United States, filed on Dec. 18, 2025, in the Korean Intellectual Property Receiving Office and claiming priority to Korean Patent Application Nos. 10-2024-0189925, filed on Dec. 18, 2024, and 10-2025-0165658, filed on Nov. 5, 2025, in the Korean Intellectual Property Office, the disclosures of each of which are incorporated by reference herein in their entireties.

### BACKGROUND

### Field

The disclosure relates to an electronic device, a method, and a non-transitory storage media for changing a screen displayed on a display.

### Description of Related Art

A growing number of diverse services and additional functions are provided through electronic devices, for example, portable electronic devices including smartphones. To increase the utility of electronic devices and to meet different users'needs, communication service providers or electronic device manufacturers are providing a wide range of functions and are competitively developing electronic devices differentiated from those of other companies. Accordingly, various functions provided through electronic devices are also becoming more sophisticated.

An electronic device may display a screen including personal information or sensitive information. For example, the electronic device may display private personal information, financial transaction information, or information bound to secrecy. In this case, to prevent/limit other people from viewing the personal information or the sensitive information, the electronic device may transform the personal information or the sensitive information included in the screen to be identifiable only by a user.

The above information is presented as background information only to assist with an understanding of the disclosure. No assertion or determination has been made, and as to whether any of the above might be applicable as prior art with regard to the disclosure.

### SUMMARY

According to an example embodiment, an electronic device may include a display, at least one processor, comprising processing circuitry, and memory storing instructions.

According to an example embodiment, at least one processor, individually and/or collectively, may be configured to execute the instructions and to cause the electronic device to display a screen including a first image showing first information on the display.

According to an example embodiment, at least one processor, individually and/or collectively, may be configured to cause the electronic device to identify information related to a pixel of at least one of an inner part or an outer part with respect to a boundary between an object representing the first information included in the first image and a background excluding the object, based on a security function for the screen being performed.

According to an example embodiment, at least one processor, individually and/or collectively, may be configured to cause the electronic device to obtain a second image in which at least one of the inner part or the outer part is adjusted, based on the information related to the pixel.

According to an example embodiment, at least one processor, individually and/or collectively, may be configured to cause the electronic device to obtain a third image in which the background included in the first image is blurred.

According to an example embodiment, at least one processor, individually and/or collectively, may be configured to cause the electronic device to obtain a fourth image using the second image and the third image. According to an example embodiment, the fourth image may be obtained by processing the first information not to be identifiable to a naked eye beyond a specified distance.

According to an example embodiment, at least one processor, individually and/or collectively, may be configured to cause the electronic device to replace the first image displayed on the screen with the fourth image.

According to an example embodiment, a method of operating an electronic device may include displaying a screen including a first image showing first information on a display of the electronic device.

According to an example embodiment, the method may include identifying information related to a pixel of at least one of an inner part or an outer part with respect to a boundary between an object representing the first information included in the first image and a background excluding the object, based on a security function for the screen being performed.

According to an example embodiment, the method may include obtaining a second image in which at least one of the inner part or the outer part is adjusted, based on the information related to the pixel.

According to an example embodiment, the method may include obtaining a third image in which the background included in the first image is blurred.

According to an example embodiment, the method may include obtaining a fourth image using the second image and the third image. According to an embodiment, the fourth image may be obtained by processing the first information not to be identifiable to a naked eye beyond a specified distance.

According to an example embodiment, the method may include replacing the first image displayed on the screen with the fourth image.

According to an embodiment, a non-transitory computer-readable storage medium may store one or more programs, which, when executed by at least one processor, comprising processing circuitry, of an electronic device, individually and/or collectively, cause the electronic device to perform operations comprising: displaying a screen including a first image showing first information on a display of the electronic device.

According to an example embodiment, the one or more programs may include instructions that, when executed by at least one processor of the electronic device, individually and/or collectively, cause the electronic device to perform operations comprising identifying information related to a pixel of at least one of an inner part or an outer part with respect to a boundary between an object representing the first information included in the first image and a background excluding the object, based on a security function for the screen being performed.

According to an example embodiment, the one or more programs may include instructions that, when executed by the at least one processor of the electronic device, individually and/or collectively, cause the electronic device to perform an operation of obtaining a second image in which at least one of the inner part or the outer part is adjusted, based on the information related to the pixel.

According to an example embodiment, the one or more programs may include instructions that, when executed by the at least one processor of the electronic device, individually and/or collectively, cause the electronic device to perform an operation of obtaining a third image in which the background included in the first image is blurred.

According to an example embodiment, the one or more programs may include instructions that, when executed by the at least one processor of the electronic device, individually and/or collectively, cause the electronic device to perform an operation of obtaining a fourth image using the second image and the third image. According to an embodiment, the fourth image may be obtained by processing the first information not to be identifiable to a naked eye beyond a specified distance.

According to an example embodiment, the one or more programs may include instructions that, when executed by the at least one processor of the electronic device, individually and/or collectively, cause the electronic device to perform an operation of replacing the first image displayed on the screen with the fourth image.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an example electronic system according to various embodiments.

FIG. 2 is a block diagram illustrating an example configuration of an electronic device according to various embodiments.

FIG. 3 is a diagram illustrating an example in which an electronic device transforms information included in a screen according to various embodiments.

FIG. 4 is a diagram illustrating an example in which an electronic device transforms information included in a screen according to various embodiments.

FIG. 5 is a flowchart illustrating an example method of operating an electronic device according to various embodiments.

FIG. 6 includes graphs and diagrams illustrating an example of an method of operating an electronic device according to various embodiments.

FIG. 7 is a diagram illustrating an example in which an electronic device adjusts a security distance according to an embodiment.

FIG. 8 is a diagram illustrating an example of an image processed not to be identifiable to the naked eye beyond a specified distance in an electronic device according to various embodiments.

FIG. 9 is a diagram illustrating an example of an image processed not to be identifiable to the naked eye beyond a specified distance in an electronic device according to various embodiments.

FIG. 10 is a diagram illustrating an example of an image processed not be identifiable to the naked eye beyond a specified distance in an electronic device according to various embodiments.

In describing the drawings, the same or like reference numerals may be used to refer to the same or like elements.

### DETAILED DESCRIPTION

Hereinafter, various example embodiments of the disclosure will be described in greater detail with reference to the accompanying drawings. However, the disclosure is not limited to the various example embodiments disclosed herein but can be realized in various other ways. In describing the drawings, the same or like reference numerals may be used to refer to the same or like elements. In the drawings and related descriptions, descriptions of well-known functions or components may be omitted for clarity and conciseness. The term “user” used in embodiments of the disclosure may refer to a person using an electronic device or an apparatus (e.g., an artificial intelligence electronic device) using an electronic device.

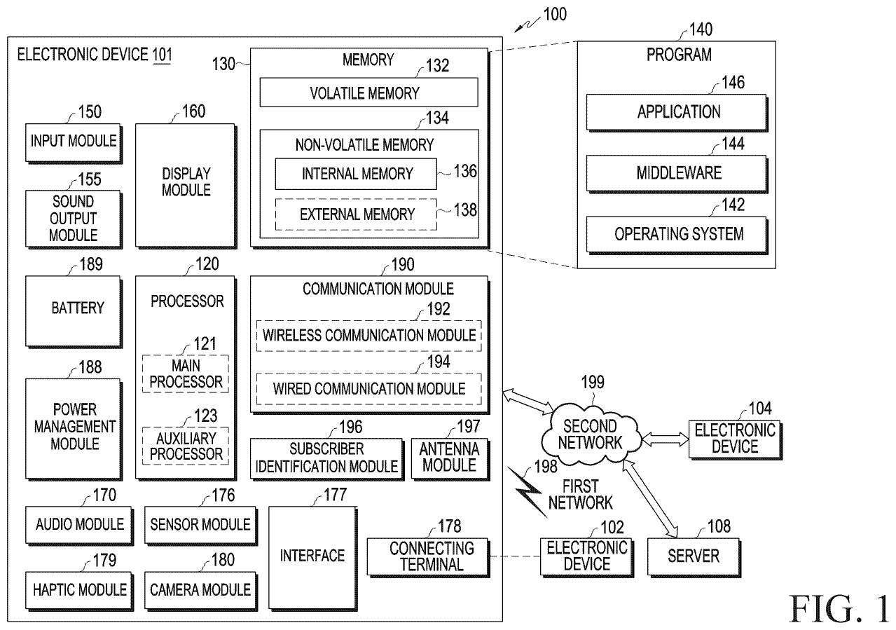

FIG. 1 is a block diagram illustrating an example electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/isclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101, According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

There may be one or more processors 120. For example, the processor 120 may be a multi-core processor, such as a dual-core processor, a quad-core processor, or a hexa-core processor.

The processor 120 may execute the instructions stored in the memory 130 to control operations of the electronic device 101. For example, the processor 120 may correspond to a plurality of processors that collectively performs a plurality of operations by dividing the operations among the plurality of processors.

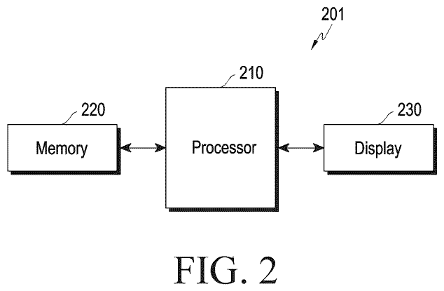

FIG. 2 is a block diagram illustrating an example configuration of an electronic device according to various embodiments.

Referring to FIG. 2, the electronic device 101 (e.g., the electronic device 101 of FIG. 1) according to an embodiment may include a processor (e.g., including processing circuitry) 210, memory 220, and a display 230. The electronic device 201 may be configured by further including various other components or by excluding some of the foregoing components, without being limited thereto.

According to an embodiment, the processor 210 (e.g., the processor 120 of FIG. 1, the description of which applies equally to the processor 210 here) may display a screen for various functions (e.g., applications) executed in the electronic device 201 on the display 230 (e.g., the display 160 of FIG. 1). For example, the screen may include an application execution screen, a home screen, a lock screen, or a pop-up window.

According to an embodiment, the processor 210 may display a screen including an original image (orgImg) (e.g., a first image) indicating first information on the display 230. For example, the first information may include a character, a number, a symbol, and/or an image included in the screen. The first information may be sensitive information, such as private personal information, financial transaction information, information bound to secrecy, and/or information allowed for only a user to view.

According to an embodiment, the processor 210 may perform a security function of transforming the information included in the screen so that the first information included in the screen is invisible to a person positioned around the electronic device and only the user is able to see the screen displayed in real time with the naked eye. According to an embodiment, the processor 210 may display an object enabling user interaction on a screen to execute the security function. According to an embodiment, the processor 210 may display a configuration screen (e.g., an editing screen) for configuring information (e.g., information related to a pixel) required for performing the security function on the display 230.

According to an embodiment, the processor 210 may perform the security function to perform an operation of transforming the first information so that only the user is able to see the first information in the screen with the naked eye.

According to an embodiment, the processor 210 may obtain a transformed image including the transformed first information, and may display a screen in which the original image is replaced with the transformed image on the display 230.

According to an embodiment, the processor 210 may be a hardware module or a software module (e.g., an application program), and may be a hardware component (function) or a software component (program) including at least one of various sensors, an input/output interface, a module that manages a state or environment of the electronic device 201, or a communication module provided in the electronic device 201.

According to an embodiment, the processor 210 may include, for example, one of hardware, software, and firmware, or a combination of two or more thereof. The processor 210 may be configured by omitting at least some of the foregoing components or by further including another component for performing an image processing operation in addition to the components.

According to an embodiment, the memory 220 (e.g., the memory 130 of FIG. 1) may store information and/or data associated with an operation of the electronic device 201. The memory 220 according to an embodiment may store at least one command (or instruction) to cause at least one operation of the electronic device 201. The at least one instruction may cause the electronic device 201 to perform the corresponding operation when executed by the processor 210.

According to an embodiment, the memory 220 may store a program (e.g., the program 140 of FIG. 1) used for a functional operation and various data generated during execution of the program. The memory 240 may mainly include a program area (e.g., the program 140 of FIG. 1) and a data area (not shown). The program area 140 may store pieces of program information for operating the electronic device 201, such as an operating system (OS) (e.g., the operating system 142 of FIG. 1) that boots the electronic device 201. The data area (not shown) may store data transmitted and/or received and generated data according to an embodiment. The memory 220 may include at least one storage medium among a flash memory, a hard disk, a multimedia card micro-type memory (e.g., a secure digital (SD) or extreme digital (XD) memory), a RAM, or a ROM. According to an embodiment, the memory 220 may store information related to a screen displayed on the display and information (e.g., a modulation parameter) related to a pixel used to transform the screen. In addition, the memory 220 may store information required to transform a screen.

According to an embodiment, the display 230 may display a screen related to a function executed in the electronic device 201. According to an embodiment, the display 230 may display a configuration screen (e.g., an editing screen) for transforming a screen. According to an embodiment, the display 240 may be configured in the form of a touchscreen. The display 240 may display various pieces of information generated according to a touch operation of the user when configured together with an input module in the form of a touchscreen. According to an embodiment, the display 240 may be configured, for example, and without limitation, as at least one of a liquid crystal display (LCD), a thin-film transistor (TFT) LCD, an organic light-emitting diode (OLED), a light-emitting diode (LED), an active-matrix organic LED (AMOLED), a micro LED, a mini LED, a flexible display, and a three-dimensional (3D) display, etc. Some of the foregoing displays may be configured as a transparent display or a light-transmitting display through which the outside may be viewed. The transparent display or light-transmitting display may be configured as a transparent display type including a transparent OLED (TOLED). According to an embodiment, the electronic device 200 may further include another display module (e.g., an extended display or a flexible display) mounted other than the display 230.

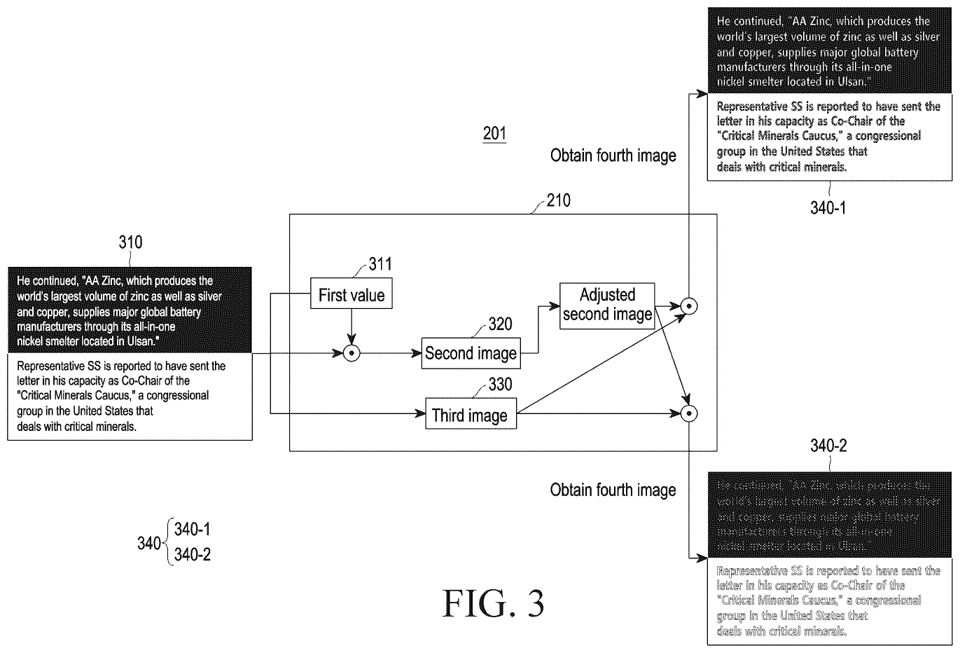

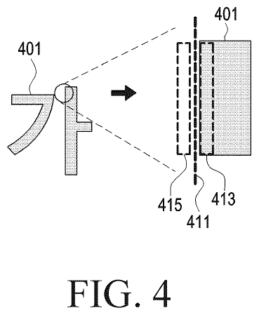

FIG. 3 is a diagram illustrating an example in which an electronic device transforms information included in a screen according to various embodiments, and FIG. 4 is a diagram illustrating an example in which an electronic device transforms information included in a screen according to various embodiments. FIG. 3 and FIG. 4 are described with reference to the components of the electronic device 201 of FIG. 2.

Referring to FIG. 3 and FIG. 4, the processor 210 of the electronic device 201 according to an embodiment may display a screen including a first image 310 (e.g., an original image (orgImg)) showing first information 311 (e.g., a letter, a number, a symbol, or an image) on the display 230.

The processor 210 according to an embodiment may identify information (e.g., a modulation parameter) related to a pixel of at least one of an inner part 413 (e.g., an inline) or an outer part 415 (e.g., an outline) with respect to a boundary 411 (e.g., an edge) between an object 401 (e.g., a letter) representing the first information included in the first image 310 (e.g., the original image) and a background excluding the object. The information related to the pixel may be information for transforming pixels corresponding to the object 401, and may include a first modulation value (e.g., edge sigma) for adjusting the thickness of at least one of the inner part 413 or the outer part 415, an amplification ratio for adjusting the contrast of the color of at least one of the inner part 413 or the outer part 415, a threshold value (e.g., a threshold value indicating a minimum pixel difference) for adjusting the softness of the color of at least one of the inner part 413 or the outer part 415, and a second modulation value (e.g., blur sigma) for adjusting the image quality (e.g., sharpness) of the background. The first modulation value may be a modulation value of a low-pass filter or a high-pass filter using a low-pass filter, and the thickness of the inner part 413 or the outer part 415 may increase as the first modulation value increases. The second modulation value may be a modulation value of a low-pass filter, and the background may be blurred as the second modulation value increases. As the amplification ratio increases, the difference between the boundary 411 and the background may increase. As the threshold value increases, the detected boundary may be reduced.

The processor 210 according to an embodiment may identify (e.g., detect or calculate) a first value (extractedLines) indicating the thickness of at least one of the inner part 413 (e.g., the inline) or the outer part 415 (e.g., the outline) by Equation 1. In Equation 1, orgImg may denote the original image, and LPF(orgImg, egdg_simga) may denote a parameter of a low-pass filter (LPF) based on the original image and the first modulation value.

$$extractedLines = orgImg - LPF ( orgImg , egdg\_simga ) \qquad [ Equation 1 ]$$

The processor 210 according to an embodiment may obtain a second image 320 in which at least one of the inner part 413 (e.g., the inline) or the outer part 415 (e.g., the outline) of the object 401 is adjusted through a high-pass filter configured using at least one high-pass filter or at least one low-pass filter, based on the information related to the pixel. The high-pass filter may include an indirect method (high-frequency image=original image−low-pass filter image) using a low-pass filter and/or a direct method (e.g., a Laplacian filter or a Sobel/Prewitt filter). For example, the parameter for adjusting the filter may be sigma used in a Gaussian filter or a kernel size (3×3 or 5×5) used in at least one of Laplacian or Sobel.

The processor 210 according to an embodiment may increase the first value by a specified amplification ratio (amplification_ratio), based on the first value being identified as exceeding a threshold value.

The processor 210 according to an embodiment may reduce the first value by a specified ratio (e.g., 1/2), based on the absolute value of the first value being identified as being less than or equal to the threshold value.

The processor 210 according to an embodiment may obtain a third image 330 (e.g., blurImg=LPF(orgImg, blur_sigma)) in which the background included in the first image (e.g., orgImg) is blurred based on the second modulation value through the low-pass filter.

The processor 210 according to an embodiment may obtain a fourth image 340 (e.g., a hybrid image) in which the first information is processed not to be identifiable to the naked eye beyond a specified distance using the second image 320 and the third image 330.

The processor 210 according to an embodiment may configure a modulation scheme differently, based on user information (e.g., age group or vision information), a content type, or a user's selection.

For example, when the user is in an age group from the 20s to the 40s and has normal vision, the processor 210 according to an embodiment may obtain the fourth image 340-1 by a first method of subtracting the second image from the third image. The fourth image 340-1 obtained by the first method may have at least one of the inner part 413 and the outer part 415 inverted in color.

For example, when the user is in an age group of the 40s or older and has farsighted vision, the processor 210 according to an embodiment may obtain a fourth image 340-2 by a second method of adding the second image to the third image. The fourth image 340-2 obtained by the second method may have the color of the inner part 413 and the outer part 415 not inverted and have been subjected to an effect of showing the object corresponding to the first information thinly.

The processor 210 according to an embodiment may display the fourth image 340 (340-1 or 340-2) on the display 230 in place of the first image 310 displayed on the screen.

According to an embodiment, the processor 210 may preconfigure a security distance to perform an operation of transforming the screen. The processor 210 may configure the security distance to a specified reference distance (e.g., 80 cm) value, and may automatically transform the screen, based on the configured security distance. The processor 210 may transform the screen, based on a security distance selected in a configuration screen through a user interaction before transforming the screen. The security distance may be preconfigured according to user information (e.g., age, vision, and/or medical history information), content information (e.g., a content type, such as a browser, an SNS application, or a messenger), or information (e.g., a font and a background color) related to the first information in the screen.

According to an embodiment, the processor 210 may configure, as a security distance, a distance selected from among distances provided through an object (e.g., a first object) for adjusting a security distance included in the configuration screen. The processor 210 may identify a security distance configured to a distance selected by the user, based on a user input to adjust a security distance being identified, may identify information (e.g., a modulation parameter) related to a specified pixel corresponding to the selected security distance using the identified security distance, and may transform a screen 703 using the identified information related to the pixel such that the first information in the screen 703 is not recognized with the naked eye at the selected security distance.

According to an embodiment, the processor 210 may adjust the security distance to a distance desired by the user, such as a close distance or a far distance, with respect to the reference distance (e.g., 80 cm) included in the first object for adjusting the security distance in the configuration screen through a user interaction. According to an embodiment, the processor 210 may configure the first modulation value (e.g., edge sigma) to increase (e.g., the thickness of the inner part or outer part to increase), the second modulation value to decrease (e.g., the blurriness of the background to decrease), the amplification ratio to increase (e.g., a contrast value to increase), and the threshold value to decrease (e.g., a detected boundary value to increase), based on the far distance being identified as being selected with respect to the reference distance. According to an embodiment, the processor 210 may configure the first modulation value (e.g., edge sigma) to decrease (e.g., the thickness of the inner part or outer part to decrease), the second modulation value to increase (e.g., the blurriness of the background to increase), the amplification ratio to decrease (e.g., the contrast value to decrease), and the threshold value to increase (e.g., the detected boundary value to decrease), based on the close distance being identified as being selected with respect to the reference distance.

An electronic device (e.g., the electronic device 101 of FIG. 1 and/or the electronic device 201 of FIG. 2) according to an example embodiment may implement a related software module (e.g., the program 140 of FIG. 1) for changing a screen displayed on a display. Memory (e.g., the memory 130 of FIG. 1 and/or the memory 420 of FIG. 4) of the electronic device may store instructions to implement the software module. At least one processor (e.g., the processor 120 of FIG. 1 and/or the processor 210 of FIG. 2) may execute the instructions stored in the memory to implement the software module, and may control hardware (e.g., the sensor module 176 and the camera module 180 of FIG. 1, the communication module 190 of FIG. 1 and/or the communication circuit 250 of FIG. 2, and the display module 160 of FIG. 1 and/or the display 230 of FIG. 2) associated with a function of the software module.

The software module of the electronic device 101 or 201 according to an embodiment may be configured including a kernel (or hardware abstraction layer (HAL)), a framework (e.g., the middleware 144 of FIG. 1), and an application (e.g., the application 146 of FIG. 1). At least part of the software module may be preloaded on the electronic device 101 or 201, or may be downloadable from a server (e.g., the server 108).

According to an embodiment, the kernel may include, for example, a system resource manager or a device driver, and may be configured to further include other modules without being limited thereto. The system resource manager may perform control, allocation, or recovery of system resources. The device driver may include, for example, a display driver, a camera driver, a Bluetooth driver, a shared memory driver, a USB driver, a keypad driver, a Wi-Fi driver, an audio driver, or an inter-process communication (IPC) driver.

According to an embodiment, the framework may provide a function commonly needed by the application or provide various functions for the application through an application programming interface (API) (not shown) so that the application may efficiently use limited system resources inside the electronic device 101 or 201. The framework may include a module that forms a combination of various functions of the components. The framework may provide a specialized module for each type of operating system in order to provide differentiated functions. The framework may dynamically delete some of the existing components or add new components. According to an embodiment, the application may include an application received from an external electronic device (e.g., the server 108 or the electronic device 102 or 104). According to an embodiment, the application may include a preloaded application or a third-party application downloadable from the server. The components of the software module according to the illustrated embodiment and the terms of the components may vary according to the type of an operating system. According to an embodiment, at least part of the software module may be implemented in software, firmware, hardware, or a combination of at least two thereof. At least part of the software module may be implemented (e.g., executed) by, for example, a processor (e.g., an application processor (AP)). At least part of the software module may include, for example, a module, a program, a routine, a set of instructions, or a process to perform at least one function.

According to an embodiment, the application may be configured to include an application (e.g., a module, a manager, or a program) for changing a screen displayed on the display. The application may include an application received from an external electronic device (e.g., the server 108 or the electronic device 102 or 104). According to an embodiment, the application may include a preloaded application or a third-party application downloadable from the server. The components of the software module according to the illustrated embodiment and the terms of the components may vary according to the type of an operating system. According to an embodiment, at least part of the software module may be implemented in software, firmware, hardware, or a combination of at least two thereof. At least part of the software module may be implemented (e.g., executed) by, for example, a processor (e.g., an AP). At least part of the software module may include, for example, a module, a program, a routine, a set of instructions, or a process to perform at least one function.

As described above, components of the electronic device are described with reference to the electronic devices 101 and 201 in FIG. 1 and FIG. 2 according to various embodiments. However, in various embodiments, not all the components illustrated in FIG. 1 and FIG. 2 may be essential components, and the electronic device 101 or 201 may be configured by more components than the illustrated components or by fewer components than the illustrated components. In addition, the positions of the main components of the electronic device 101 or 201 described with reference to FIG. 1 and FIG. 2 may be changed according to various embodiments.

According to an example embodiment, an electronic device (e.g., the electronic device 101 of FIG. 1 and/or the electronic device 201 of FIG. 2) may include a display (e.g., the display 160 of FIG. 1 and/or the display 230 of FIG. 2), at least one processor including processing circuitry (e.g., the processor 120 of FIG. 1 and/or the processor 210 of FIG. 2), and memory (e.g., the memory 130 of FIG. 1 and/or the memory 220 of FIG. 2) storing instructions.

According to an example embodiment, the instructions may, when individually or collectively executed by the at least one processor, cause the electronic device to display a screen including a first image showing first information on the display.

According to an example embodiment, the instructions may, when individually or collectively executed by the at least one processor, cause the electronic device to identify information related to a pixel of at least one of an inner part or an outer part with respect to a boundary between an object representing the first information included in the first image and a background excluding the object, based on a security function for the screen being performed.

According to an example embodiment, the instructions may, when individually or collectively executed by the at least one processor, cause the electronic device to obtain a second image in which at least one of the inner part or the outer part is adjusted, based on the information related to the pixel.

According to an example embodiment, the instructions may, when individually or collectively executed by the at least one processor, cause the electronic device to obtain a third image in which the background included in the first image is blurred.

According to an example embodiment, the instructions may, when individually or collectively executed by the at least one processor, cause the electronic device to obtain a fourth image using the second image and the third image. According to an embodiment, the fourth image may be obtained by processing the first information not to be identifiable to a naked eye beyond a specified distance.

According to an example embodiment, the instructions may, when individually or collectively executed by the at least one processor, cause the electronic device to replace the first image displayed on the screen with the fourth image.

According to an example embodiment, the information related to the pixel may include a first modulation value for adjusting the thickness of at least one of the inner part or the outer part, an amplification ratio for adjusting the contrast of the color of at least one of the inner part or the outer part, a threshold value for adjusting the softness of the color of at least one of the inner part or the outer part, and a second modulation value for adjusting the image quality of the background.

According to an example embodiment, the instructions may, when individually or collectively executed by the at least one processor, cause the electronic device to: obtain a first value by detecting the thickness of at least one of the inner part or the outer part through a high-pass filter configured using at least one low-pass filter; obtain the second image by increasing the first value by the amplification ratio, based on the first value being identified as exceeding the threshold value; and obtain the second image by reducing the first value by a specified ratio, based on the absolute value of the first value being identified as being less than or equal to the threshold value.

According to an example embodiment, the instructions may, when individually or collectively executed by the at least one processor, cause the electronic device to obtain the third image, based on the at least one second modulation value using the at least one low-pass filter.

According to an example embodiment, the instructions may, when individually or collectively executed by the at least one processor, cause the electronic device to generate the fourth image to which color inversion is applied with respect to the boundary by subtracting the second image from the third image.

According to an example embodiment, the instructions may, when individually or collectively executed by the at least one processor, cause the electronic device to generate the fourth image to which an effect of showing the object thin without color inversion by adding the second image to the third image.

According to an example embodiment, the instructions may, when individually or collectively executed by the at least one processor, cause the electronic device to control the display to display a configuration screen for adjusting a security distance so that the information is not identifiable to a naked eye beyond the specified distance with respect to a specified reference distance value, based on user information and content information.

According to an example embodiment, the instructions may, when individually or collectively executed by the at least one processor, cause the electronic device to configure the information related to the pixel to increase the first modulation value, to decrease the second modulation value, to increase the amplification ratio, and to decrease the threshold value, based on the security distance being identified as having adjusted to a distance value exceeding the reference distance value.

According to an example embodiment, the instructions may, when individually or collectively executed by the at least one processor, cause the electronic device to configure the information related to the pixel to decrease the first modulation value, to increase the second modulation value, to decrease the amplification ratio, and to increase the threshold value, based on the security distance being identified as having adjusted to a distance value less than the reference distance value.

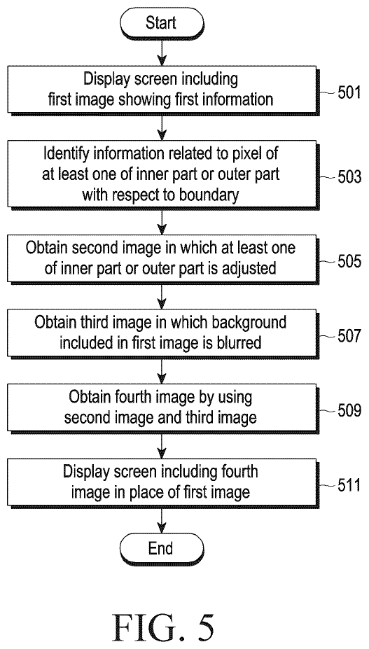

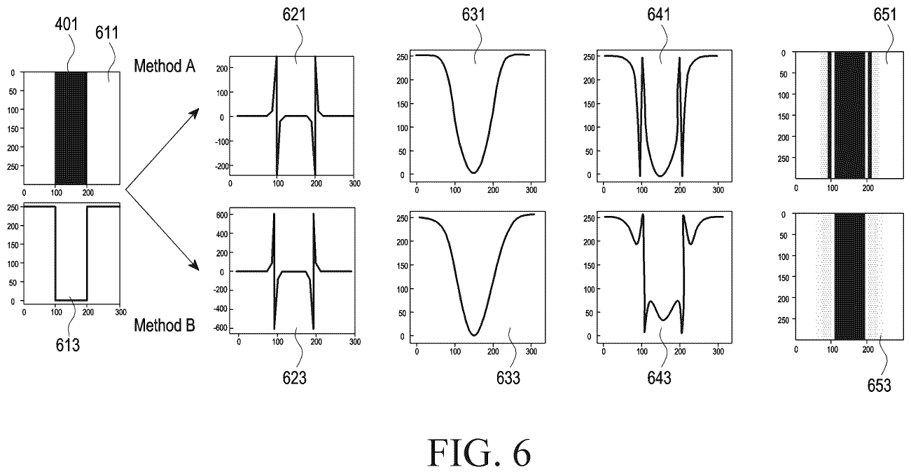

FIG. 5 is a flowchart illustrating an example method of operating an electronic device according to various embodiments, and FIG. 6 includes graphs and diagrams illustrating an example method of operating an electronic device according to various embodiments. In the following example embodiments, operations may be sequentially performed but are not necessarily sequentially performed. For example, the order of the operations may be changed, and at least two operations may be performed in parallel.

Referring to FIG. 5 and FIG. 6, in operation 501, the electronic device (e.g., the electronic device 101 of FIG. 1 and/or the electronic device 201 of FIG. 2) according to an embodiment may display a screen including a first image (e.g., the first image 310 of FIG. 3 or an original image) showing first information on a display (e.g., the display module 160 of FIG. 1 and/or the display 230 of FIG. 2). For example, the screen may include an execution screen of an application, a home screen, a lock screen, or a pop-up window. The first information may be sensitive information, such as private personal information, financial transaction information, information bound to secrecy, and/or information allowed for only a user to view.

In operation 503, according to an embodiment, the electronic device may identify information related to a pixel of at least one of an inner part or an outer part with respect to a boundary between an object representing the first information included in the first image and a background excluding the object, based on a security function for the screen being performed. According to an embodiment, the electronic device may identify information (e.g., a modulation parameter) related to a pixel of at least one of an inner part (e.g., the inner part 413 of FIG. 4) or an outer part (e.g., the outer part 415 of FIG. 4) with respect to a boundary (e.g., the boundary 411 of FIG. 4) between an object 401 (e.g., the object 401 of FIG. 4) representing the first information included in the first image and a background excluding the object 401. The information related to the pixel may be information for transforming pixels corresponding to the object, and may include a first modulation value (e.g., edge sigma) for adjusting the thickness of at least one of the inner part or the outer part, an amplification ratio for adjusting the contrast of the color of at least one of the inner part or the outer part, a threshold value for adjusting the softness of the color of at least one of the inner part or the outer part, and a second modulation value (e.g., blur sigma) for adjusting the image quality (e.g., sharpness) of the background. The first modulation value may be a modulation value of a low-pass filter or a high-pass filter using a low-pass filter, and the thickness of the inner part 413 or the outer part 415 may increase as the first modulation value increases. The second modulation value may be a modulation value of a low-pass filter, and the background may be blurred as the second modulation value increases. As the amplification ratio increases, the difference between the boundary 411 and the background may increase. As the threshold value increases, the detected boundary may be reduced.

In operation 505, according to an embodiment, the electronic device may obtain a second image (e.g., the second image 320 of FIG. 3) in which at least one of the inner part or the outer part of the object 401 is adjusted, based on the information related to the specified pixel. According to an embodiment, the electronic device may identify (e.g., detect) the thickness (e.g., a first value) of at least one of the inner part or the outer part of the object corresponding to the first information through a high-pass filter configured using at least one low-pass filter, based on a first modulation value. According to an embodiment, the electronic device may increase the first value by a specified amplification ratio (amplification_ratio), based on the first value being identified as exceeding a threshold value by comparing the identified thickness with the threshold value. According to an embodiment, the electronic device may reduce the first value by a specified ratio (e.g., 1/2), based on the absolute value of the first value being identified as being less than or equal to the threshold value. According to an embodiment, the electronic device may obtain an adjusted second image by reflecting at least one of a transformed inner part or a transformed outer part.

In operation 507, according to an embodiment, the electronic device may obtain a third image (e.g., the third image 330 of FIG. 3) in which the background included in the first image is blurred. According to an embodiment, the electronic device may obtain the third image (e.g., blurImg=LPF(orgImg, blur_sigma)) in which the background included in the first image (e.g., orgImg) is blurred, based on a second modulation value through the low-pass filter.

In operation 509, according to an embodiment, the electronic device may obtain a fourth image (e.g., the fourth image 340 (340-1 or 340-2) of FIG. 3) in which the first information is processed not to be identifiable to the naked eye beyond a specified distance using the second image and the third image.

According to an embodiment, the electronic device may configure a modulation scheme differently, based on user information (e.g., age group or vision information), a content type, or a user's selection. According to an embodiment, for example, when the user is in an age group from the 20s to the 40s and has normal vision, the electronic device may obtain a fourth image 340-1 by a first method of subtracting the second image from the third image. The fourth image 340-1 obtained by the first method (e.g., method A) may have a transformed object 651 obtained by inverting at least one of the inner part 413 (e.g., the inner part 413 of FIG. 4) or the outer part (e.g., the outer part 415 of FIG. 4) of the object 401 in color as shown in FIG. 6. According to an embodiment, for example, when the user is in an age group of the 40s or older and has farsighted vision, the electronic device may obtain a fourth image 340-2 by a second method (method B) of adding the second image to the third image. The fourth image 340-2 obtained by the second method may have a transformed object 653 obtained by not inverting the color of the inner part 413 (e.g., the inner part 413 of FIG. 4) or the outer part (e.g., the outer part 415 of FIG. 4) of the object 401 and applying an effect of showing the object corresponding to the first information thinly as shown in FIG. 6. According to an embodiment, the electronic device may identify a color through a pixel-form graph 613 of the object 401 of the first image (e.g., the original image) as shown in FIG. 6. According to an embodiment, the electronic device may identify the color of the object 401 and the color of the background 611 through a pixel-form graph (e.g., user image pixel forms 621 and 623 and surfer image pixel forms 631 and 633) of the object 401 of the second image (e.g., a high-frequency image) as shown in FIG. 6. According to an embodiment, the electronic device may identify that the fourth images (e.g., the fourth images 340-1 and 340-2 of FIG. 3) obtained by the first and second methods by the electronic device may be hybrid images obtained by synthesizing the second image and the third image and that the color of the inner part 413 (e.g., the inner part 413 of FIG. 4) or the outer part (e.g., the outer part 415 of FIG. 4) is inverted as in graphs 641 and 643 showing the pixel forms of the hybrid images. The graphs 621, 623, 631, 633, 641, and 643 may represent pixel intensity (e.g., 0 to 255) in a gray channel, in which a larger value may indicate a brighter color.

In operation 511, according to an embodiment, the electronic device may display the fourth image on the display in place of the first image displayed on the screen.

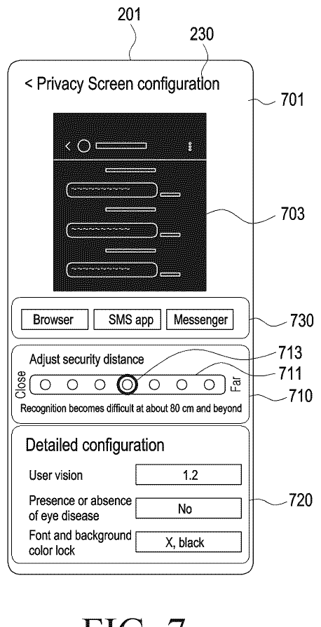

FIG. 7 is a diagram illustrating an example in which an electronic device adjusts a security distance according to various embodiments. Referring to FIG. 7, the electronic device 201 (e.g., the electronic device 101 of FIG. 1 and/or the electronic device 201 of FIG. 2) according to an embodiment may configure a security distance so that first information included in a screen 301 is not discernible to the naked eye by another person beyond a specified distance. The electronic device 201 may configure the security distance by a user interaction through a configuration screen 701 (e.g., a privacy screen configuration screen) displayed on a display 230 (e.g., the display 160 of FIG. 1 and/or the display 230 of FIG. 2). The configuration screen 701 may include a screen 703 to be transformed, a first object 710 for adjusting the security distance, and a second object 720 for a detailed configuration. The first object 710 may include a distance adjustment object 711 configured, for example, in a bar shape to configure a security distance to a certain interval, and may include a message (e.g., “Recognition becomes difficult at about 80 cm and beyond.”) for informing another person of a reference distance 711 (e.g., a minimum distance) at which recognition with the naked eye becomes difficult or a visual effect (e.g., a bold circular marker indicating the reference distance 711). The second object 720 may include pieces of information (e.g., user vision (e.g., 1.2), presence or absence of an eye disease (e.g., no), and font and background color lock (e.g., X, black)) for the detailed configuration for transforming the screen 703. A third object 730 may include content information (e.g., a content type, such as a browser, an SNS application, or a messenger) about the screen 701.

According to an embodiment, the electronic device 201 may select the security distance from the first object 710 through a user interaction, may identify information (e.g., a modulation parameter) related to a specified pixel corresponding to the selected security distance, and may transform the screen 703 using the identified information related to the pixel such that the first information on the screen 703 is not recognized with the naked eye at the selected security distance. The information (e.g., the modulation parameter) related to the specified pixel may include a first modulation value (e.g., edge sigma) for adjusting the thickness of at least one of an inner part or an outer part, an amplification ratio for adjusting the contrast of the color of at least one of the inner part or the outer part, a threshold value for adjusting the softness of the color of at least one of the inner part or the outer part, and a second modulation value (e.g., blur sigma) for adjusting the image quality (e.g., sharpness) of a background.

According to an embodiment, the electronic device 201 may adjust the security distance to a close distance (e.g., a short distance) or a far distance with respect to the reference distance 711 (e.g., 80 cm) included in the first object 710, based on user information (e.g., age group or vision information) and/or a content type.

According to an embodiment, the electronic device 201 may adjust the security distance to a distance desired by a user, such as a close distance or a far distance, with respect to the reference distance 713 (e.g., 80 cm) in the distance adjustment object 711 included in the first object 710 through a user interaction.

According to an embodiment, the electronic device 201 may configure the first modulation value (e.g., edge sigma) to increase (e.g., the thickness of the inner part or outer part to increase), the second modulation value to decrease (e.g., the blurriness of the background to decrease), the amplification ratio to increase (e.g., a contrast value to increase), and the threshold value to decrease (e.g., a detected boundary value to increase), based on the security distance being identified as having adjusted to a far distance (e.g., a distance value exceeding a reference distance value) with respect to the reference distance 713.

According to an embodiment, the electronic device 201 configure the first modulation value (e.g., edge sigma) to decrease (e.g., the thickness of the inner part or outer part to decrease), the second modulation value to increase (e.g., the blurriness of the background to increase), the amplification ratio to decrease (e.g., the contrast value to decrease), and the threshold value to increase (e.g., the detected boundary value to decrease), based on the security distance being identified as having adjusted to a close distance (e.g., a distance value less than the reference distance value) with respect to the reference distance 713.

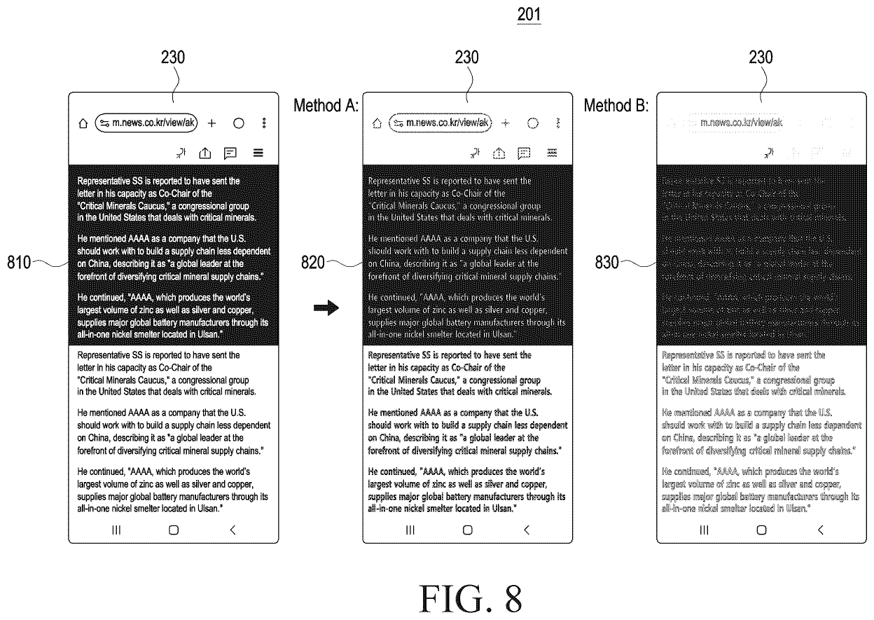

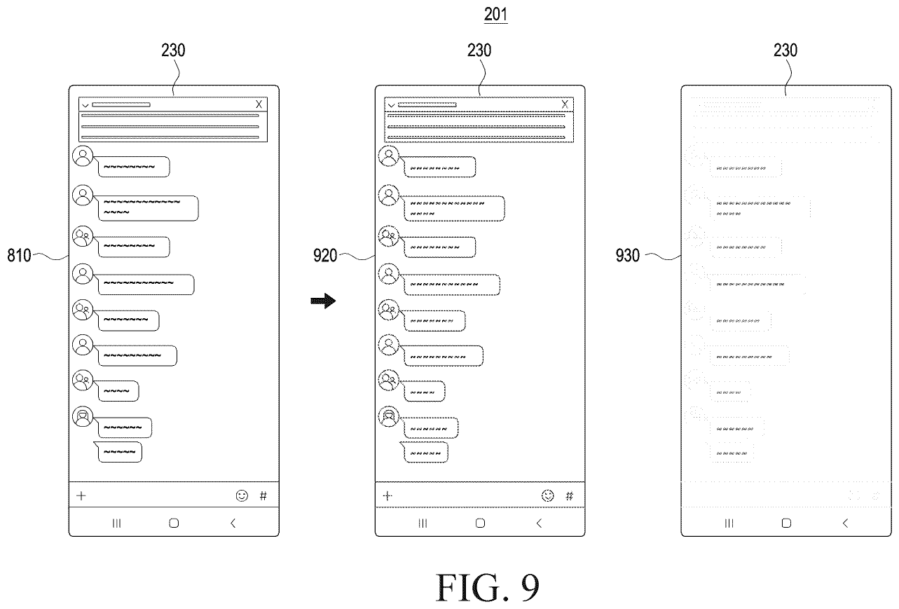

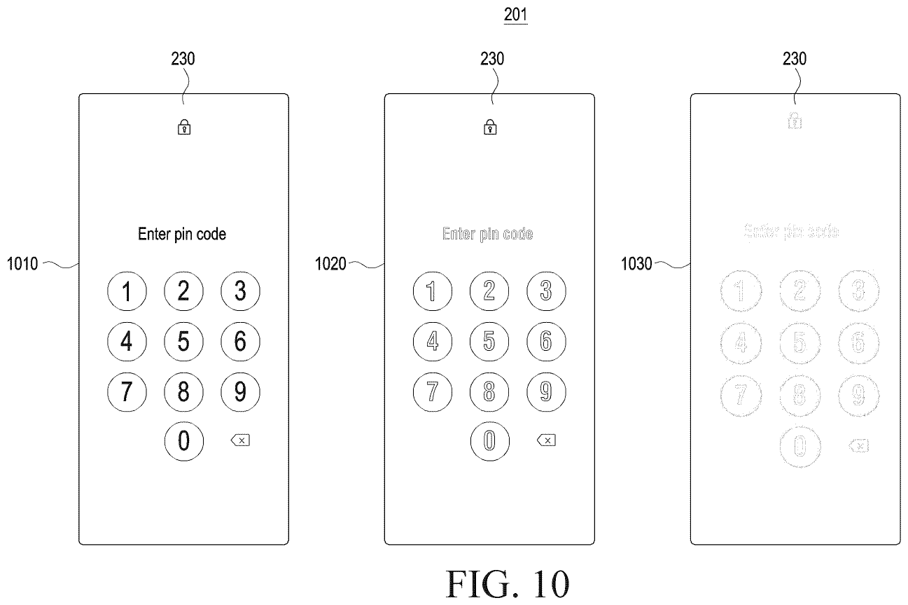

FIG. 8, FIG. 9, and FIG. 10 are diagrams illustrating examples of images processed not to be identifiable to the naked eye beyond a specified distance in an electronic device according to various embodiments. Referring to FIG. 8, the electronic device 201 (e.g., the electronic device 101 of FIG. 1 and/or the electronic device 201 of FIG. 2) according to an embodiment may obtain an image (e.g., a fourth image) by transforming text, which is first information included in a screen 810 of text content displayed in real time on a display 230 (e.g., the display 160 of FIG. 1 and/or the display 230 of FIG. 2), so that an object representing the text is not recognized by another person with the naked eye, and may display transformed screens 820 and 830 including the obtained image in real time on the display 230. The transformed screen 820 may include the image (e.g., the fourth image) processed by a first method (to which a contrast effect is applied by color inversion). The transformed screen 830 may include the image (e.g., the fourth image) processed by a second method (to which an effect of showing the object thinly is applied).

Referring to FIG. 9, the electronic device 201 (e.g., the electronic device 101 of FIG. 1 and the electronic device 201 of FIG. 2) according to an embodiment may obtain an image (e.g., a fourth image) by transforming object so that an object representing a message (e.g., a message including text, an image, and/or a symbol), which is first information included in a screen 910 of a messenger application displayed in real time on a display 230 is not recognized by another person with the naked eye, and may display transformed screens 920 and 930 including the obtained image in real time on the display 230. The transformed screen 920 may include the image (e.g., the fourth image) processed by a first method (to which a contrast effect is applied by color inversion). The transformed screen 930 may include the image (e.g., the fourth image) processed by a second method (to which an effect of showing the object thinly is applied).

Referring to FIG. 10, the electronic device 201 (e.g., the electronic device 101 of FIG. 1 and the electronic device 201 of FIG. 2) according to an embodiment may obtain an image (e.g., a fourth image) by transforming object so that an object representing a keypad or pattern, which is first information included in a screen 1010 of a lock function (PIN) displayed in real time on a display 230 is not recognized by another person with the naked eye, and may display transformed screens 1020 and 1030 including the obtained image in real time on the display 230. The transformed screen 1020 may include the image (e.g., the fourth image) processed by a first method (to which a contrast effect is applied by color inversion). The transformed screen 1030 may include the image (e.g., the fourth image) processed by a second method (to which an effect of showing the object thinly is applied).

An electronic device according to an embodiment may transform screens of various content, applications, or functions including private personal information, financial transaction information, information bound to secrecy, or information configured to be protected by a user so as not to be recognized by another person with the naked eye in addition to the screens illustrated in FIG. 8 to FIG. 10.

According to an example embodiment, a method of operating an electronic device (e.g., the electronic device 101 of FIG. 1 and/or the electronic device 201 of FIG. 2) may include displaying a screen including a first image showing first information on a display (e.g., the display 160 of FIG. 1 and/or the display 230 of FIG. 2) of the electronic device.

According to an example embodiment, the method may include identifying information related to a pixel of at least one of an inner part or an outer part with respect to a boundary between an object representing the first information included in the first image and a background excluding the object, based on a security function for the screen being performed.

According to an example embodiment, the method may include obtaining a second image in which at least one of the inner part or the outer part is adjusted, based on the information related to the pixel.

According to an example embodiment, the method may include obtaining a third image in which the background included in the first image is blurred.

According to an example embodiment, the method may include obtaining a fourth image using the second image and the third image. According to an embodiment, the fourth image may be obtained by processing the first information not to be identifiable to a naked eye beyond a specified distance.

According to an example embodiment, the method may include replacing the first image displayed on the screen with the fourth image.

According to an example embodiment, the information related to the pixel may include a first modulation value for adjusting the thickness of at least one of the inner part or the outer part, an amplification ratio for adjusting the contrast of the color of at least one of the inner part or the outer part, a threshold value for adjusting the softness of the color of at least one of the inner part or the outer part, and a second modulation value for adjusting the image quality of the background.

According to an example embodiment, the obtaining of the second image may include obtaining a first value by detecting the thickness of at least one of the inner part or the outer part through a high-pass filter configured using at least one low-pass filter, obtaining the second image by increasing the first value by the amplification ratio, based on the first value being identified as exceeding the threshold value, and obtaining the second image by reducing the first value by a specified ratio, based on the absolute value of the first value being identified as being less than or equal to the threshold value.

According to an example embodiment, the obtaining of the third image may include obtaining the third image, based on the at least one second modulation value using the at least one low-pass filter.

According to an example embodiment, the obtaining of the fourth image may include generating the fourth image to which color inversion is applied with respect to the boundary by subtracting the second image from the third image.

According to an example embodiment, the obtaining of the fourth image may include generating the fourth image to which an effect of showing the object thin without color inversion by adding the second image to the third image.

According to an example embodiment, the method may further include displaying, on the display, a configuration screen for adjusting a security distance so that the information is not identifiable to a naked eye beyond the specified distance with respect to a specified reference distance value, based on user information and content information.

According to an example embodiment, the method may further include configuring the information related to the pixel to increase the first modulation value, to decrease the second modulation value, to increase the amplification ratio, and to decrease the threshold value, based on the security distance being identified as having adjusted to a distance value exceeding the reference distance value.

According to an example embodiment, the method may further include configuring the information related to the pixel to decrease the first modulation value, to increase the second modulation value, to decrease the amplification ratio, and to increase the threshold value, based on the security distance being identified as having adjusted to a distance value less than the reference distance value.

According to an example embodiment, a non-transitory storage medium may store one or more programs, wherein the one or more programs may include instructions that, when executed by at least one processor (e.g., the processor 120 of FIG. 1 and/or the processor 210 of FIG. 2) of an electronic device (e.g., the electronic device 101 of FIG. 1 and/or the electronic device 201 of FIG. 2), cause the electronic device to perform an operation of displaying a screen including a first image showing first information on a display (e.g., the display 160 of FIG. 1 and/or the display 230 of FIG. 2) of the electronic device.

According to an example embodiment, the one or more programs may include instructions that, when executed by the at least one processor of the electronic device, cause the electronic device to perform an operation of identifying information related to a pixel of at least one of an inner part or an outer part with respect to a boundary between an object representing the first information included in the first image and a background excluding the object, based on a security function for the screen being performed.

According to an example embodiment, the one or more programs may include instructions that, when executed by the at least one processor of the electronic device, cause the electronic device to perform an operation of obtaining a second image in which at least one of the inner part or the outer part is adjusted, based on the information related to the pixel.

According to an example embodiment, the one or more programs may include instructions that, when executed by the at least one processor of the electronic device, cause the electronic device to perform an operation of obtaining a third image in which the background included in the first image is blurred.

According to an example embodiment, the one or more programs may include instructions that, when executed by the at least one processor of the electronic device, cause the electronic device to perform an operation of obtaining a fourth image using the second image and the third image. According to an embodiment, the fourth image may be obtained by processing the first information not to be identifiable to a naked eye beyond a specified distance.

According to an example embodiment, the one or more programs may include instructions that, when executed by the at least one processor of the electronic device, cause the electronic device to perform an operation of replacing the first image displayed on the screen with the fourth image.

According to the disclosure, it is possible to prevent/limit a screen displayed on electronic device from being easily visible or discernible to other people in a public place, such as public transportation, the outdoors, and working spaces, to prevent/limit a user's personal information from being easily stolen through peeping by others, and to prevent/limit a user's personal preferences and tendencies from being indiscriminately exposed to other people in public places. In addition, various effects directly or indirectly identified through this disclosure may be provided. Effects obtainable from the disclosure are not limited to the effects mentioned above, and other effects not mentioned will be clearly understood by those skilled in the art from the description.

Embodiments disclosed herein are presented merely to easily describe technical details of the disclosure and to help the understanding of the disclosure, and are not intended to limit the scope of the disclosure. Accordingly, the scope of the disclosure should be understood as including all modifications or various other embodiments based on the technical idea of the disclosure. It will also be understood that any of the embodiment(s) described herein may be used in conjunction with any other embodiment(s) described herein.

The electronic device according to various embodiments may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
at least one processor, comprising processing circuitry; and
memory storing instructions,
wherein at least one processor, individually and/or collectively, is configured to execute the instructions and to cause the electronic device to:
display a screen including a first image representing first information on the display;
based on performing a security function for the screen, identify information related to at least one pixel of an inner part or an outer part based on a boundary between an object representing the first information included in the first image and a background excluding the object;
based on information related to the pixel, obtain a second image in which at least one of the inner part or the outer part is adjusted;
obtain a third image in which the background included in the first image is blurred;
obtain a fourth image using the second image and the third image, wherein the fourth image is processed so that the first information is not discernible to a naked eye beyond a specified distance; and
replace the first image displayed on the screen with the fourth image.

2. The electronic device of claim 1,
wherein information related to the pixel may include a first modulation value for adjusting a thickness of at least one of the inner portion or the outer portion, an amplification ratio for adjusting a contrast of a color of at least one of the inner portion or the outer portion, a threshold value for adjusting softness of a color of at least one of the inner portion or the outer portion, and a second modulation value for adjusting a resolution of the background.

3. The electronic device of claim 2, wherein at least one processor, individually and/or collectively, is configured to cause the electronic device to:
obtain a first value obtained by detecting the thickness of at least one of the inner portion or the outer portion through a high-frequency filter configured using at least one low-frequency filter;
based on identifying that the first value exceeds the threshold value, obtain the second image by increasing the first value by the amplification ratio; and
based on identifying that the absolute value of the first value is less than or equal to the threshold value, obtain the second image by decreasing the first value by a specified ratio.

4. The electronic device of claim 2, wherein at least one processor, individually and/or collectively, is configured to cause the electronic device to:
based on the at least one second modulation value, obtain the third image using the at least one low-pass filter.

5. The electronic device of claim 4, wherein at least one processor, individually and/or collectively, is configured to cause the electronic device to:
generate the fourth image with color inversion applied centered on the boundary by subtracting the second image from the third image.

6. The electronic device of claim 4, wherein at least one processor, individually and/or collectively, is configured to cause the electronic device to:
generate the fourth image with the effect of making the object appear thinner without color inversion by adding the second image to the third image.

7. The electronic device of claim 1, wherein at least one processor, individually and/or collectively, is configured to cause the electronic device to:
based on user information and content information, control the display to display a setting screen for adjusting the security distance so that so that the first information is not discernible to a naked eye beyond the specified distance based on a specified reference distance value.

8. The electronic device of claim 7, wherein at least one processor, individually and/or collectively, is configured to cause the electronic device to:
based on identifying that the security distance has been adjusted to a distance value greater than the reference distance value, set information related to the pixel to increase the first modulation value, decrease the second modulation value, increase the amplification ratio, and decrease the threshold value.

9. The electronic device of claim 7, wherein at least one processor, individually and/or collectively, is configured to cause the electronic device to:
based on identifying that the security distance is adjusted to a distance value less than the reference distance value, set information related to the pixel to decrease the first modulation value, increase the second modulation value, decrease the amplification ratio, and increase the threshold value.

10. A method of operating an electronic device, the method comprising:
displaying a screen comprising a first image representing first information on a display of the electronic device;
based on performing a security function for the screen, identifying information related to a pixel of at least one of an inner part or an outer part with respect to a boundary between an object representing the first information included in the first image and a background excluding the object;
based on the information related to the pixel, obtaining a second image in which at least one of the inner part or the outer part is adjusted;
obtaining a third image in which the background included in the first image is blurred;
obtaining a fourth image using the second image and the third image, the fourth image being processed such that the first information is not discernible to a naked eye beyond a specified distance; and
replacing the first image displayed on the screen with the fourth image.

11. The method of claim 10, wherein the information related to the pixel comprises a first modulation value for adjusting a thickness of at least one of the inner part or the outer part, an amplification ratio for adjusting a contrast of a color of at least one of the inner part or the outer part, a threshold value for adjusting softness of a color of at least one of the inner part or the outer part, and a second modulation value for adjusting an image quality of the background.

12. The method of claim 11, wherein the obtaining of the second image comprises:
obtaining a first value by detecting the thickness of at least one of the inner part or the outer part through a high-pass filter configured using at least one low-pass filter;
based on identifying that the first value exceeds the threshold value, obtaining the second image by increasing the first value by the amplification ratio; and
based on identifying that an absolute value of the first value is less than or equal to the threshold value, obtaining the second image by reducing the first value by a specified ratio.

13. The method of claim 11, wherein the obtaining of the third image comprises obtaining the third image, based on the at least one second modulation value, using at least one low-pass filter.

14. The method of claim 13, wherein the obtaining of the fourth image comprises generating the fourth image with color inversion applied thereto with respect to the boundary by subtracting the second image from the third image.

15. The method of claim 13, wherein the obtaining of the fourth image comprises generating the fourth image with an effect of making the object look thin without color inversion by adding the second image to the third image.

16. The method of claim 10, further comprising, based on user information and content information, displaying, on the display, a configuration screen for adjusting a security distance such that the first information is not discernible to a naked eye beyond the specified distance with respect to a specified reference distance value.

17. The method of claim 16, further comprising, based on identifying that the security distance has been adjusted to a distance value exceeding the reference distance value, configuring the information related to the pixel to increase the first modulation value, decrease the second modulation value, increase the amplification ratio, and decrease the threshold value.

18. The method of claim 16, further comprising, based on identifying that the security distance has been adjusted to a distance value less than the reference distance value, configuring the information related to the pixel to decrease the first modulation value, increase the second modulation value, decrease the amplification ratio, and increase the threshold value.

19. A non-transitory computer-readable storage medium storing one or more programs, the one or more programs comprising instructions that, when executed by at least one processor, comprising processing circuitry, of an electronic device, individually and/or collectively, cause the electronic device to perform operations comprising:
displaying a screen comprising a first image showing first information on a display of the electronic device;
based on performing a security function for the screen, identifying information related to a pixel of at least one of an inner part or an outer part with respect to a boundary between an object representing the first information included in the first image and a background excluding the object;
based on the information related to the pixel, obtaining a second image in which at least one of the inner part or the outer part is adjusted;
obtaining a third image in which the background included in the first image is blurred;
obtaining a fourth image using the second image and the third image, the fourth image being processed such that the first information is not discernible to a naked eye beyond a specified distance; and
replacing the first image displayed on the screen with the fourth image.

20. The non-transitory computer-readable storage medium of claim 19, wherein the information related to the pixel comprises a first modulation value for adjusting a thickness of at least one of the inner part or the outer part, an amplification ratio for adjusting a contrast of a color of at least one of the inner part or the outer part, a threshold value for adjusting softness of a color of at least one of the inner part or the outer part, and a second modulation value for adjusting an image quality of the background.
